(19) United States
(12) Patent Application Publication
(10) Pub. No.: US 2009/0210286 A1
(43) Pub. Date: Aug. 20, 2009

(54) METHOD FOR AUTOMATIC OPTIMIZED PRICE DISPLAY

(75) Inventor: Chatschik Bisdikian, Chappaqua, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 12/030,926

(22) Filed: Feb. 14, 2008

(51) Int. Cl. G06Q 10/00

(52) U.S. Cl. 705/10

(57) ABSTRACT

A method of updating prices, includes automatically and continually adjusting prices of goods and services provided by a company through local outlets located across a geographic area, including activating trigger sources, the trigger sources including static and dynamic causes, inputting additional parameters, the parameters including a competitor's name, location, price of an item, a time and date, and an observed popularity of an item, storing the additional parameters in a historical database, making dynamic decisions for adjusting the prices across the local outlets based on the trigger sources and the additional parameters, the making dynamic decisions being based on the trigger sources, the additional parameters, and company selected criteria, which includes revenue targets, market conditions, market forecasts, and historical data, automatically adjusting a price of goods and services provided by the company.

### BACKGROUND OF THE INVENTION

1. Field of the Invention

The present invention generally relates to a method and apparatus for updating inventory data, and more particularly to a method and apparatus for dynamically updating the price of items stored on shelves in a retail store.

2. Description of the Related Art

It is a common practice among large retail-store chains to adjust downwards the prices of their merchandise to maintain an edge against their competitors. Specifically, retailers in a region will offer merchandises at a sales (e.g., promotional) price over an advertised period of time. Competitor retail-stores in the region will typically respond by matching prices for the identical or similar merchandises. While reduced prices improve sales opportunities, prolonged “price wars” between retailers in the region may effect the bottom line and cause the retailer to miss desired revenue targets not only regionally, but nationally (or internationally).

Electronic price tags have been introduced and used in retail space as a means to ease the process of updating the price of items stored on shelves in retail stores (e.g., supermarkets, department stores, auto dealerships, etc.). One such conventional approach is directed to shelf tag systems based on electronic tags that can be programmed with the latest prices via an in-store LAN or a via portable programming device. The prices are read from data stored in databases located at the retail store or elsewhere. The conventional systems focus exclusively on the use of electronic/programmable price tags and how they can be programmed.

### SUMMARY OF THE INVENTION

One aspect not considered by the conventional methods is the reasons under which information on these tags has to change and in particular the exploitation of the capability to adjust “advertised” prices for items on store shelves for reasons other than seasonal promotions.

In view of the foregoing and other exemplary problems, drawbacks, and disadvantages of the conventional methods and structures, an exemplary feature of the present invention is to provide a method and structure in which prices of items stored on shelves in retail stores are updated dynamically.

In an exemplary, non-limiting aspect of the present invention, a method of updating prices, includes automatically and continually adjusting prices of goods and services provided by a company through local outlets located across a geographic area, the company including a hierarchy including a pricing headquarters, a plurality of regional headquarters, and the local outlets, the automatically and continually adjusting prices including activating trigger sources, the trigger sources including static and dynamic causes, the static and dynamic causes including periods throughout a year in which a retailer typically initiates price reductions, unpredictable temporal changes in supply and demand, competitive pressure in a region of the geographic area, local information, global information, and information obtained through direct inspection of a competitor's prices, inputting additional parameters, the parameters including a competitor's name, location, price of an item, a time and date, and an observed popularity of an item, storing the additional parameters in a historical database, making dynamic decisions for adjusting the prices across the local outlets based on the trigger sources and the additional parameters, the making dynamic decisions being based on the trigger sources, the additional parameters, and company selected criteria, which includes revenue targets, market conditions, market forecasts, and historical data, automatically adjusting a price of goods and services provided by the company.

A large chain retailer may want to maintain an edge against their competitors by dynamically adjusting the price of their merchandise whenever they can afford to do so. With flexible pricing mechanisms they can reduce prices in a region for certain periods, while increasing prices in other regions to maintain to the degree possible their overall revenue forecasts. By continuously optimizing their regional pricing plans by adjusting prices up and down at different regions dynamically allows retailers to maintain a competitive edge without significantly compromising their overall earnings forecasts. The latest decided upon prices can be dynamically updated on the store floor with minimal human involvement and without disturbing the store operations.

Accordingly, an exemplary aspect of the claimed invention is directed to a method (and system) that enables retailers operating over a large geographical region (e.g., national or international retailers) to manage merchandise (or services in general) pricing dynamically in order to maintain a competitive advantage regionally against the competition while controlling the effects on the overall, long term revenue targets.

As indicated above, retail-store chains maintain an edge against their competitors by dynamically adjusting the price of their merchandise whenever they can afford to do so. In accordance with an exemplary aspect of the present invention is directed to a method (and system) according to which flexible pricing mechanisms are used to reduce prices in a region for certain periods, while increasing prices in a controlled fashion in other regions to maintain, to the degree possible, their overall revenue forecasts. By continuously optimizing their regional pricing plans and by adjusting prices up and down at different regions dynamically, an exemplary aspect of the method of the present invention allows retailers to maintain a competitive edge without compromising their overall earnings forecasts. Furthermore, the latest selected prices for the merchandises affected by these adjustments can be dynamically updated on the store floor with minimal human involvement and without the disturbing the store operations.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary large retail store chain with retail outlets (or stores) and various regions and regional headquarters;

FIG. 2 illustrates an exemplary pricing decision making hierarchy according to an exemplary, non-limiting embodiment of the present invention;

FIG. 3 illustrates a pricing method according to an exemplary, non-limiting embodiment of the present invention; and

FIG. 4 illustrates exemplary price adjustment equations according to an exemplary, non-limiting embodiment of the present invention.

### DETAILED DESCRIPTION OF EXEMPLARY EMBODIMENTS OF THE INVENTION

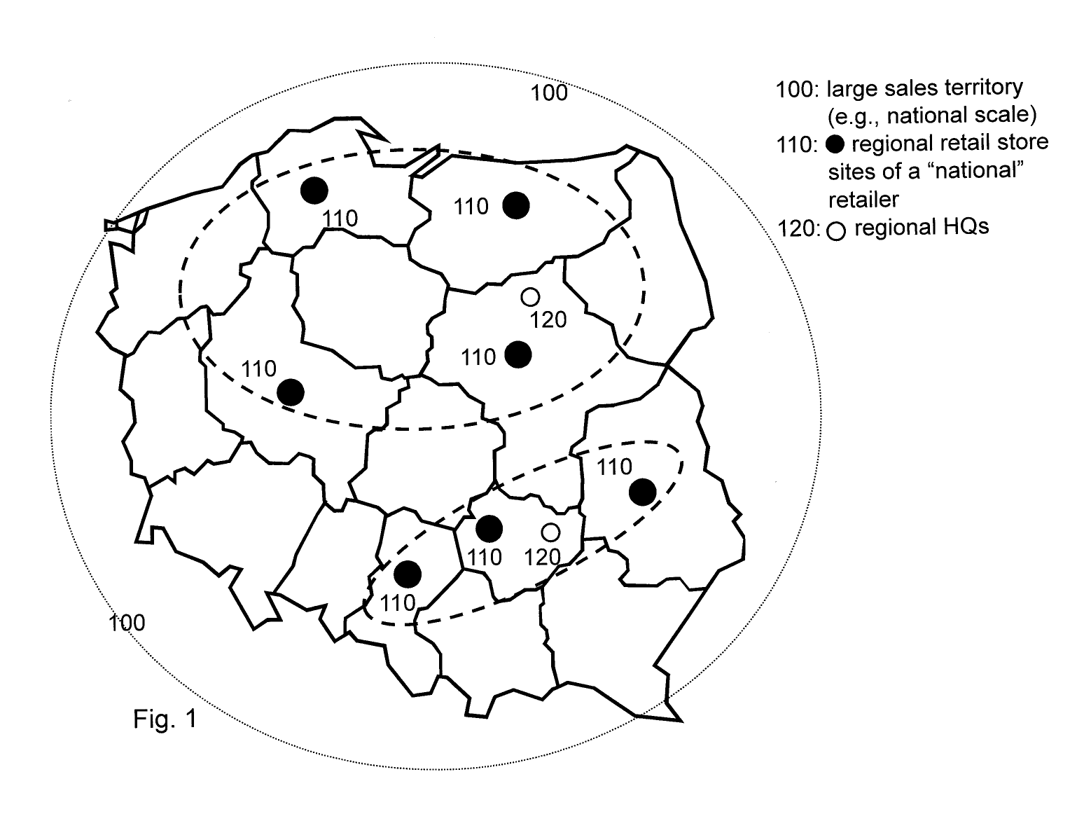

Referring now to the drawings, and more particularly to FIGS. 1-4, there are shown exemplary embodiments of the method and structures according to the present invention.

While the exemplary, non-limiting embodiments of the present invention may be instantiated within different contexts, it is presented here via an exemplary embodiment within the context of a national retail-store chain that exemplifies a typical use case for the invention.

According to an exemplary, non-limiting embodiment of the present invention, FIG. 1 illustrates a large geographical region, possibly an entire country, 100, divided into smaller geographical sub-regions in some of which the large retail chain of this exemplary embodiment has retail outlets 110 (or stores). The geographical sub-regions may coincide with “governmental” geographical divisions (e.g., counties, cantons, prefectures, municipalities, etc.) or other divisions found convenient by the retail store operators. Retail stores in nearby sub-regions are under the administrative domain of regional headquarters (HQ) 120 (e.g., the regional headquarters for the northeast region of a country). In general, the role of the regional headquarter is to provide sales and distribution services that is tuned to the needs of the local stores under its jurisdiction. However, and specifically within the context of the exemplary embodiment of our invention, the role of the regional headquarters is to provide pricing guidelines, sales targets, etc., (potentially reflecting guidelines set forward at the national headquarters) to support the dynamic price adjustment procedures of the present invention.

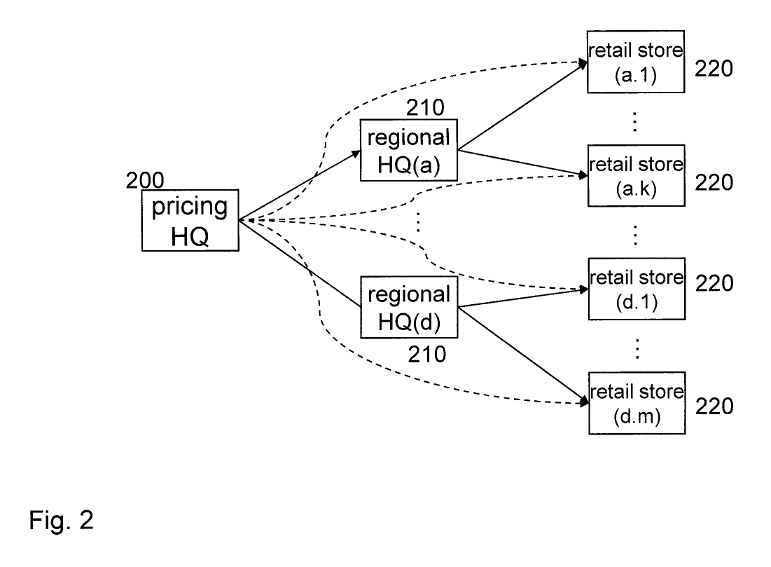

FIG. 2 illustrates a retail store chain including a pricing HQ tier (e.g., the headquarters of the sales division), which influences a number of regional pricing tiers, which then influence the merchandise prices at a number of retail outlets.

In more detail, FIG. 2 shows a 3-tier structure involving national 200 and regional pricing centers 210, and the retail stores 220. Specifically, the pricing headquarter tier (e.g., the headquarters of the sales division) sets sales and pricing guidelines for a number of regional pricing tiers to follow, which in turn provide a set of pricing guidelines for the merchandise on the floor of the retail stores under their administrative jurisdiction. The 3-tier structure shown in FIG. 2 may represent three successive tiers in the retail chain hierarchy, or it may represent a subset of tiers in the hierarchy not necessarily successive.

Furthermore, the pricing headquarters may not necessarily represent the highest pricing decision tier in the retail-store organization hierarchy but simply the highest pricing decision tier involved at a particular instance. This will allow decentralized decision making (within reasonable constraints, of course) and faster response to regional needs. Based on a pricing strategy, the pricing headquarter may instruct a regional tier to adjust prices on the outlets that it administers (the solid arrows in FIG. 2), or it may instruct the outlets directly to adjust prices (the dashed arrows in the figure). The latter case may be more appropriate when price adjustments may have to apply simultaneously to more that one administrative domain.

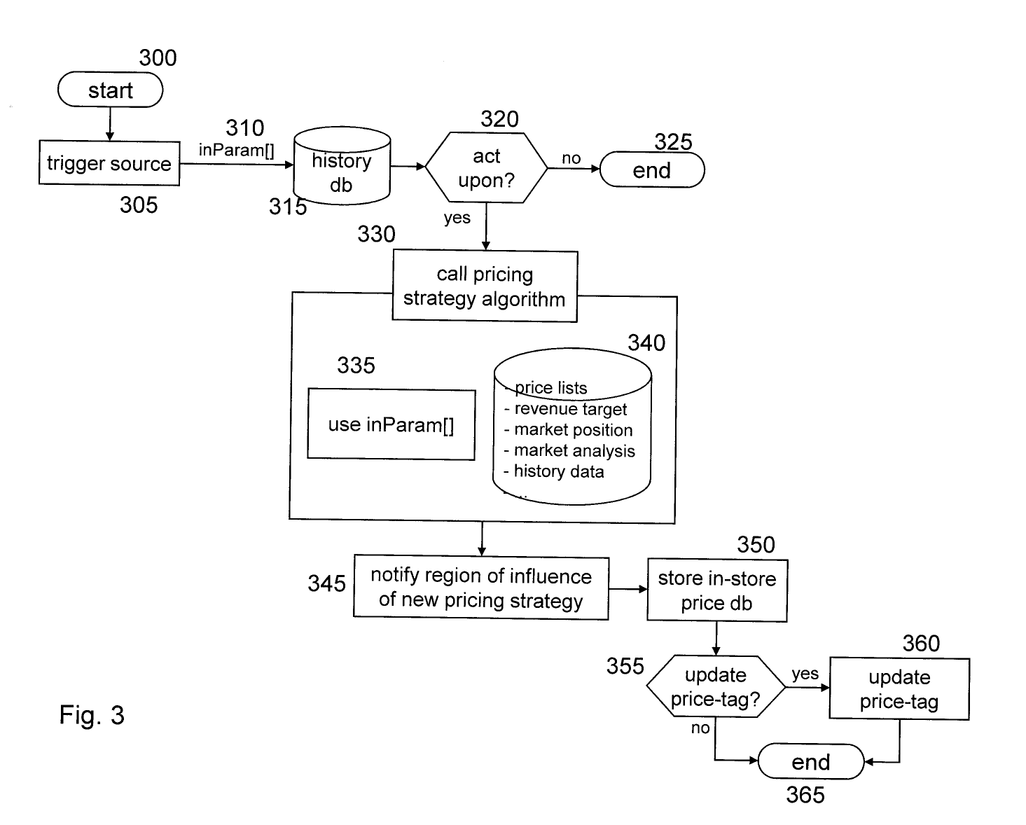

FIG. 3 illustrates the steps of a price adjustment method for adjusting dynamically merchandise prices according to an exemplary, non-limiting embodiment of the present invention invention. FIG. 3 illustrates one iteration of the method which loops over and over from start to end.

An iteration loop starts 300 with the activation of trigger sources 305. The trigger sources represent causes that initiate (i.e., trigger) the execution of the price adjustment method. Trigger sources include both static and dynamic causes. For example, retailers will typically designate certain periods in a year as sales periods where merchandise are sold at reduced prices. Since these periods are typically known well in advanced, any price reductions during these periods would have already accounted for when sale targets and price policies are set-up (e.g., at the beginning of the year). On the other hand, based on unpredictable temporal changes in supply and demand for certain merchandise, sudden competitive pressure in a region, etc., decisions to adjust their prices may also be triggered in a dynamic and unpredictable manner.

Additional trigger sources may include local information (e.g., weekly advertisement circulars from competitors that advertise sales prices for merchandise they sale—retail stores in the region may have to match their sales prices for the same or similar merchandise).

Trigger sources may also include “global” price information available on the Web, for example, from sites that provide price comparisons for various merchandise offered by different e-tailers (on-line retailers). Trigger sources may also include information provided by direct inspection (e.g., an employee of the exemplary retail store visits a competitor's store(s) to observe and report merchandise prices). Provided that the appropriate infrastructure is set-up, upon observing a more favorable price on a item or two, the employee may trigger the pricing adjustment mechanism on the spot by simply calling a special phone number or accessing a special Web-site via his/her portable data capable personal device.

As the trigger source triggers the price adjustment method, additional information may be provided that can be used as an input parameter by the method. This information, shown as inparam[ ] 310 in FIG. 3, may include the competitors' name, location, price of item, time and day, observed popularity of item, and so on. This information may be kept in a history database 315 for future use. With the trigger source 305 triggering the price adjustment method and the inparamt[ ] 310 providing a context for the price adjustment, a decision is first taken 320 whether to proceed with the price adjustment (e.g., it may not worth adjusting prices for items that are not very popular, or the profit margins for certain are too low to consider further price reduction). If the decision is against proceeding with the method, the method terminates 325 and the process returns back to the start 300.

If a decision to activate the price adjustment method is made, then the method will typically make use of the parameters 335 provided during trigger, plus additional information pertaining to the price objectives, revenue targets, risk analysis data (from market analysis), etc. 340. Upon making a decision about pricing, the decision (or pricing strategy) will be passed to the entities lower in the store hierarchy as necessary 345 (e.g., see FIG. 2). The new prices will eventually be propagated to the retail stores, either via regional centers or directly from the pricing headquarter (as illustrated in FIG. 2). To maintain the overall revenue objectives, the new prices in some of the stores will be lower than the previous ones for the same items and some other stores will be higher. At the retail stores, the new prices are stored at a local pricing database 350. Note that a local database may not be physically located at the store itself, but may be a virtual database located at some remote location which is nevertheless directly accessible by the local store.

The pricing strategy may also provide instructions as to whether the price tags on the store floor will need to be updated with a new price 355. If the price tags need to be updated, then the prices are updated in all the price tags and an in-store announcement board referring to the price of the affected merchandise 360. Then, the iteration loop of the method terminates and returns back to the start 300. It is possible that a lower price on the price tags may not be updated to allow a local store manager to exercise his/her own judgment in advertising the new (lower) price. For example, the manager may decide to continue advertising the original price, but offer the lower deal to individuals that bargain for a more favorable price.

Updating price tags may depend on the price tag technology used. In the traditional fashion, it will require that new paper price tags be printed and manually replace (or placed on top) the old price tags. With the introduction of electronic price tags, the price tags themselves can be reused but they may have to be reprogrammed to display the updated price tag. This can be done by having an employee reprogramming one-by-one each tag, either manually or through some form of a near-field programming device. Using remotely controlled addressable electronic price tags, the price tags can even be programmed from a central monitor location at the store or from another remote location, e.g., the pricing headquarters. The latter case allows the execution of the pricing strategy to be transparent to the local store operations, eventually reducing cost and achieving high-level of dynamicity in its execution.

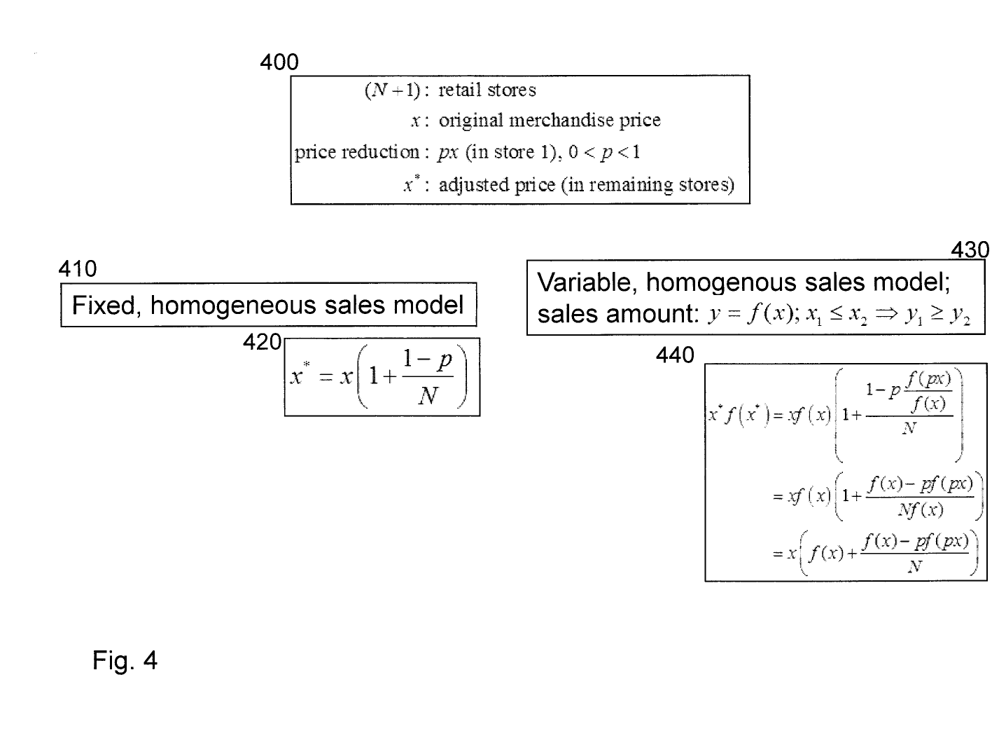

FIG. 4 illustrates exemplary embodiments for the formulae that can be used for price adjustments. For these exemplary formulae, the following assumptions were made 400: The price adjustment strategy impact (N+1) retail stores, one being the store with the merchandise that is the reason for triggering the price adjustment and the remaining N stores whose sales prices are affected by the price adjustment 400. The original price of the merchandise in questions is x (in all stores), and the sales price for the merchandise will be p·x, where 0<p<1. Under a fixed homogenous sales model 410, we assume that nominally (i.e., if no price adjustments were to be made) all the stores project to sale the same quantity of the merchandise, and that the average quantity of the merchandise to be sold does not change significantly with its adjusted cost, which is then approximated by a constant amount of sales independently of the price (within reason of course). In this case, equation 420 represents the adjusted price x* for this merchandise in the remaining N stores to compensate the revenue loss due to the lowering of the price of the merchandise (i.e., p·x) in the first store.

If, in contrast to the fixed model 410, the quantity of the merchandise to be sold is reflective to its price, but otherwise the nominal sales projections for all the stores are again identical, then the variable, homogenous sales model 430 can be used. According to this model, the quantity of sales y for the merchandise is projected to be y=f(x), for some non-increasing function f(.) of the retail price x of the merchandise (we assume that the amount of sales y does not decrease with decreasing price x). In this case, the equation 440 provides for the functional expression that the adjusted price x*, in the remaining N stores, will need to satisfy. Standard mathematical techniques for solving equations can be used to solve 440, like the Newton-Raphson iterative algorithm. Clearly, when f(x) is fixed independently of x, equation 440 reduces to 420.

Those skilled in the art may use alternative adjustment formulae without departing from the spirit of this invention. For example, they may consider more elaborate sales and price models where the nominal projected sales quantities in the N+1 stores may not be identical, consider price adjustments for multiple merchandise simultaneously, or consider the case where the price adjustment in one merchandise influences the prices of more than one item in the same or different stores as well. In the latter case, the decrease in price in one store would be balanced by price increases not only for the same merchandise across all other stores but across multiple merchandise as well, each one of which may, hence, see its price adjusted upward only slightly.

The present invention may be used with an information handling/computer system, which preferably has at least one processor or central processing unit (CPU).

The CPUs are interconnected via a system bus to a random access memory (RAM), read-only memory (ROM), input/output (I/O) adapter (for connecting peripheral devices such as disk units and tape drives to the bus 1112), user interface adapter (for connecting a keyboard, mouse, speaker, microphone, and/or other user interface device to the bus), a communication adapter for connecting an information handling system to a data processing network, the Internet, an Intranet, a personal area network (PAN), etc., and a display adapter for connecting the bus to a display device and/or printer (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of computer-readable instructions. These instructions may reside in various types of computer-readable media.

Thus, this aspect of the present invention is directed to a programmed product, comprising computer-readable media tangibly embodying a program of computer-readable instructions executable by a digital data processor incorporating the CPU and hardware above, to perform the method of the invention.

This computer-readable media may include, for example, a RAM contained within the CPU, as represented by the fast-access storage for example. Alternatively, the instructions may be contained in another computer-readable media, such as a magnetic data storage diskette, directly or indirectly accessible by the CPU. Whether contained in the diskette, the computer/CPU, or elsewhere, the instructions may be stored on a variety of computer-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable computer-readable media including transmission media such as digital and analog and communication links and wireless. In an illustrative embodiment of the invention, the computer-readable instructions may comprise software object code.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of updating prices, comprising:
automatically and continually adjusting prices of goods and services provided by a company through local outlets located across a geographic area, said company comprising a hierarchy including a pricing headquarters, a plurality of regional headquarters, and said local outlets,
said automatically and continually adjusting prices comprising:
activating trigger sources, said trigger sources comprising static and dynamic causes, said static and dynamic causes comprising periods throughout a year in which a retailer typically initiates price reductions, unpredictable temporal changes in supply and demand, competitive pressure in a region of the geographic area, local information, global information, and information obtained through direct inspection of a competitor's prices;
inputting additional parameters, said parameters comprising a competitor's name, location, price of an item, a time and date, and an observed popularity of an item;
storing said additional parameters in a historical database;
making dynamic decisions for adjusting said prices across said local outlets based on said trigger sources and said additional parameters, said making dynamic decisions being based on said trigger sources, said additional parameters, and company selected criteria, which includes revenue targets, market conditions, market forecasts, and historical data;
automatically adjusting a price of goods and services provided by said company.

2. The method according to claim 1, further comprising:
passing said dynamic decisions from said pricing headquarters to said plurality of regional headquarters and then to said local outlets;
storing adjusted price information in a local pricing database; and
adjusting the price of goods and services at said local outlets.

3. The method according to claim 2, wherein said automatically adjusting the price of goods and services at said local outlets comprises reducing the price of goods and services in some of said local outlets and increasing the price of goods and services at other local outlets.

4. The method according to claim 3, wherein said automatically adjusting the price of goods and services at said local outlets comprises updating price tags in said local outlets.

5. The method according to claim 4, wherein said price tags comprise remotely controllable electronic price tags.
